(19) United States
(12) Patent Application Publication
(10) Pub. No.: US 2025/0053994 A1
(43) Pub. Date: Feb. 13, 2025

(54) STANDALONE WEBSITE ORDER AFTER-SALES METHOD AND APPARATUS, DEVICE, AND MEDIUM

(71) Applicant: ASPED NETWORK TECHNOLOGY (SHANGHAI) CO., LTD., Shanghai (CN)

(72) Inventors: Tao ZHOU, Shanghai (CN); Weiyi Chen, Shanghai (CN)

(21) Appl. No.: 18/669,404

(22) Filed: May 20, 2024

(30) Foreign Application Priority Data
Aug. 8, 2023 (CN) 202310997917.2

(51) Int. Cl. G06Q 30/016; G06Q 20/40

(52) U.S. Cl. CPC G06Q 30/016; G06Q 20/401

(57) ABSTRACT

A standalone website order after-sales method and apparatus, a device and a medium, the method including: receiving an order generation request sent by user equipment, where the order generation request includes a commodity identification and a user identification; generating a commodity order according to the order generation request; sending the commodity order to the user equipment to enable the user equipment to complete payment for the commodity order; in response to a completion of the payment for the commodity order, generating an after-sales token corresponding to the commodity order; sending a commodity order confirmation email to a user mailbox corresponding to the user identification, where the commodity order confirmation email includes an after-sales link of the commodity order, and the after-sales link includes the after-sales token corresponding to the commodity order.

### CROSS-REFERENCE TO RELATED DISCLOSURE

This application claims priority to Chinese Patent Application No. 202310997917.2, filed on Aug. 8, 2023, which is hereby incorporated by reference in its entirety.

### TECHNICAL FIELD

The present application relates to the field of computer technology and, in particular, to a standalone website order after-sales method and apparatus, a device and a medium.

### BACKGROUND

While a cross-border e-commerce company operates and sells through a standalone website, a user may purchase different commodities on different standalone websites.

After the user places an order for a commodity on a standalone website, if there is an after-sales problem, the user needs to find a contact email address of a merchant on the standalone website where the commodity was purchased, and contact the merchant by email to conduct an after-sales service or make a complaint. However, when the user needs an after-sales service or needs to make a complaint, it is possible that the user cannot conduct an after-sales service or make a complaint due to situations where the user forgets the website address of the standalone website, the standalone website is out of service, and the contact email address of the merchant is incorrect, etc.

### SUMMARY

The present application provides a standalone website order after-sales method and apparatus, a device, and a medium for solving problems in the prior art that it is difficult for a user to conduct an after-sales service and make a complaint and it is difficult for a merchant to provide after-sales services and deal with complaints in a process of selling commodities through the operation of a standalone website.

In a first aspect, the present application provides a standalone website order after-sales method, applied to a payment service device, including:
receiving an order generation request sent by user equipment; the order generation request including a commodity identification and a user identification;
generating a commodity order according to the order generation request;
sending the commodity order to the user equipment to enable the user equipment to complete payment for the commodity order;
in response to a completion of the payment for the commodity order, generating an after-sales token corresponding to the commodity order; and
sending a commodity order confirmation email to a user mailbox corresponding to the user identification; where the commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order.

In a second aspect, the present application provides a standalone website order after-sales apparatus, applied to a payment service device, including:
a receiving module, configured to receive an order generation request sent by user equipment; the order generation request including a commodity identification and a user identification;
a first generating module, configured to generate a commodity order according to the order generation request;
a first sending module, configured to send the commodity order to the user equipment to enable the user equipment to complete payment for the commodity order;
a second generating module, configured to generate an after-sales token corresponding to the commodity order in response to a completion of the payment for the commodity order; and
a second sending module, configured to send a commodity order confirmation email to a user mailbox corresponding to the user identification; where the commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order.

In a third aspect, the present application provides a payment service device, including: a memory, a processor, and a transceiver;
where the memory, the processor, and the transceiver are interconnected through a circuitry;
the memory stores a computer executable instruction;
the transceiver is configured to send and receive data; and
the processor executes the computer executable instruction stored in the memory to implement the method as described in the first aspect.

In a fourth aspect, the present application provides a computer readable storage medium, the computer readable storage medium storing a computer executable instruction which, when executed by a processor, implements the method as described in the first aspect.

In a fifth aspect, the present application provides a computer program product including a computer program which, when executed by a processor, implements the method as described in the first aspect.

The present application provides a standalone website order after-sales method and apparatus, a device and a medium, applied to a payment service device, with which an order generation request sent by user equipment is received, where the order generation request includes a commodity identification and a user identification; a commodity order is generated according to the order generation request; the commodity order is sent to the user equipment to enable the user equipment to complete payment for the commodity order; in response to a completion of the payment for the commodity order, an after-sales token corresponding to the commodity order is generated; a commodity order confirmation email is sent to a user mailbox corresponding to the user identification, where the commodity order confirmation email includes an after-sales link of the commodity order, and the after-sales link includes the after-sales token corresponding to the commodity order; the after-sales token is used for identifying the commodity order, the after-sales link points to a commodity after-sales page in the payment service device, and when the user equipment accesses the after-sales link, the payment service device determines the commodity order corresponding to the after-sales token to be a target order for which an after-sales service is required, and provides the after-sales service for a user according to at least one piece of target status information of the target order. Since the payment service device generates the after-sales token corresponding to the commodity order after the payment for the order completes on the user equipment, the after-sales token is used to identify the commodity order, and the order confirmation email including the after-sales link is sent to the user mailbox. The after-sales link points to the payment service device, thus a user may access the payment service device through the after-sales link when the user needs an after-sales service. Since the after-sales link includes the after-sales token, when the after-sales link is accessed, the payment service device may determine, according to the after-sales token, the target order for which an after-sales service is required and may provide the after-sales service to the user with the at least one piece of target status information of the target order. In conclusion, solutions in the present application can provide a stable after-sales service to the user.

### BRIEF DESCRIPTION OF DRAWINGS

Drawings herein, which are incorporated into the specification and form a part of the specification, show embodiments consistent with the present application and are used together with the specification to explain principles of the present application.

FIG. 1 is a network architecture diagram corresponding to an application scenario of a standalone website order after-sales method provided according to an embodiment of the present application.

FIG. 2 is a flow diagram of a standalone website order after-sales method provided according to a first embodiment of the present application.

FIG. 3 is a flow diagram of a standalone website order after-sales method provided according to a second embodiment of the present application.

FIG. 4 is a structure diagram of a standalone website order after-sales apparatus provided according to a third embodiment of the present application.

FIG. 5 is a structure diagram of a payment service device provided according to a fourth embodiment of the present application.

Specific embodiments of the present application have been shown by means of the above-mentioned drawings, and there will be more detailed description in the following. These drawings and textual descriptions are not intended to limit in any way the scope of conceptions of the present application, but rather to illustrate concepts of the present application for those skilled in the art by reference to particular embodiments.

### DESCRIPTION OF EMBODIMENTS

Terms “first”, “second”, etc., in the specification, claims and the drawings of embodiments in the present application are used to distinguish similar objects without necessity to be used to describe a particular order or sequence. It should be understood that data used in such way may be interchangeable where appropriate so that the embodiments of the present invention described herein can be implemented in an order other than those illustrated or described herein. In addition, terms “including” and “having”, as well as any variations thereof, are intended to cover non-exclusive inclusion, for example, processes, methods, systems, products, or devices including a series of steps or units need not be limited to those steps or units clearly listed, but may include other steps or units which are not clearly listed or other steps or units which are inherent to these processes, methods, products or devices.

Terms involved in the present application are first explained.

An Internet protocol address is also known as an IP address. The Internet protocol address is a uniform address format provided by the IP protocol, which assigns a logical address to every network and every host on the Internet in order to shield differences in physical addresses.

A uniform resource locator, which is abbreviated to URL, is a concise representation of a location and an access method of a resource which can be obtained from the Internet, and is an address of a standard resource on the Internet.

A link is also known as a hyperlink and can point to a URL.

The prior art involved in the present application is described and analyzed in detail in the following.

A merchant, when conducting standalone website operating and selling, may have a plurality of standalone websites at the same time, and a user may browse and shop for commodities on web pages of the standalone websites after accessing the standalone websites. After purchasing a commodity, if the user needs to conduct an after-sales service or make a complaint, the user has to contact the merchant through a contact email address of the merchant on a standalone website to conduct an after-sales service or make a complaint. Users may not specially record a website address of a standalone website when purchasing commodities. Even if a user records a website address of a standalone website on which a commodity is purchased, when the user needs an after-sales service, the standalone website on which the user purchased the commodity may be out of service due to a business adjustment of the merchant or other reasons. Moreover, an email address left by the merchant on the standalone website may be incorrect, which makes it impossible for the user to contact the merchant through the email address.

In conclusion, in the prior art, there is a problem that it is difficult for a user to conduct an after-sales service and make a complaint after purchasing a commodity on a standalone website.

While facing the problem in the prior art, the inventors carry on a creative research: in order to ensure that a user is able to conduct an after-sales service or make a complaint after purchasing a commodity on a standalone website, it is necessary to provide the user with a stable after-sales channel, and when commodities are purchased, it is usually necessary to make payments, thus, it is possible to provide the user with a stable after-sales link by a payment service device, to ensure that the user is able to conduct an after-sales service or make a complaint.

Therefore, the inventors propose, in the present application, a technical solution applied to a payment service device, with which an order generation request sent by user equipment is received, where the order generation request includes a commodity identification and a user identification; a commodity order is generated according to the order generation request; the commodity order is sent to the user equipment to enable the user equipment to complete payment for the commodity order; in response to a completion of the payment for the commodity order, an after-sales token corresponding to the commodity order is generated; a commodity order confirmation email is sent to a user mailbox corresponding to the user identification, where the commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order. Since the payment service device generates the after-sales token corresponding to the commodity order after the payment for the order completes on the user equipment, the after-sales token is used to identify the commodity order, and the order confirmation email including the after-sales link is sent to the user mailbox. The after-sales link points to the payment service device, thus a user may access the payment service device through the after-sales link when the user needs an after-sales service. Since the after-sales link includes the after-sales token, when the after-sales link is accessed, the payment service device may determine, according to the after-sales token, the target order for which an after-sales service is required and may provide the after-sales service to the user with the at least one piece of target status information of the target order.

The present application provides a standalone website order after-sales method and apparatus, a device, and a medium, which are intended to solve the technical problem in the prior art as described above. The technical solution of the present application and how the technical solution of the present application solves the technical problem as described above are described in detail in the following with specific embodiments. Following specific embodiments may be combined with each other, and same or similar concepts or processes may not be repeated in certain embodiments.

A network architecture and an application scenario of a standalone website order after-sales method provided by an embodiment of the present application are introduced in the following. When a following description relates to the drawings, same data in different drawings represents same or similar elements unless otherwise indicated.

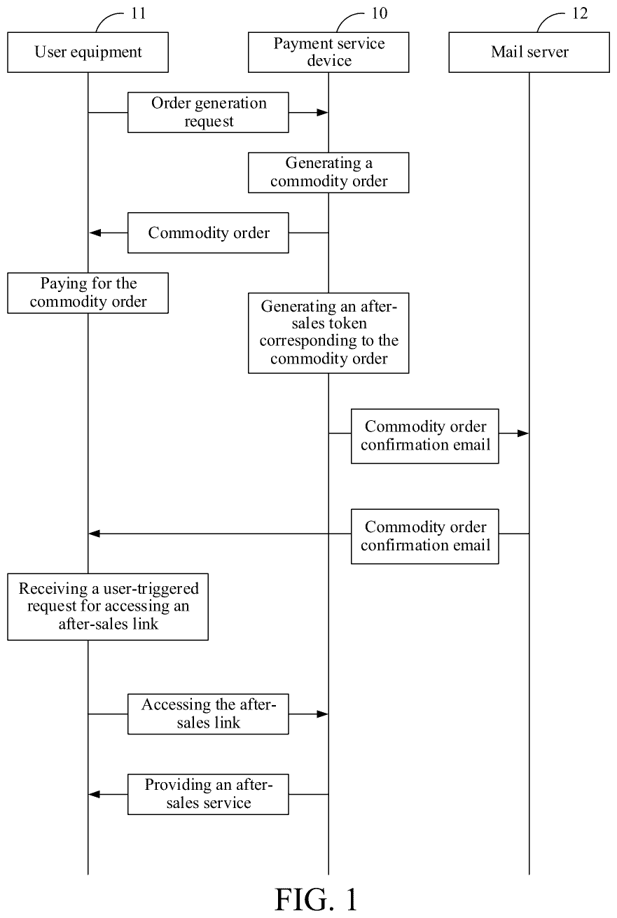

FIG. 1 is a network architecture diagram corresponding to the application scenario of the standalone website order after-sales method according to the embodiment of the present application. As shown in FIG. 1, the network architecture corresponding to the application scenario provided by the embodiment of the present application includes: a payment service device 10, user equipment 11, and a mail server 12.

A user browses a web page of a standalone website by means of the user equipment 11 and, after selecting a commodity, sends an order generation request to the payment service device 10.

The payment service device 10 receives the order generation request from the user equipment 11; where the order generation request includes a commodity identification and a user identification.

The payment service device 10 generates a commodity order according to the order generation request; and sends the commodity order to the user equipment 11 to enable the user equipment 11 to complete payment for the commodity order.

The user equipment 11 receives the commodity order and completes the payment for the commodity order.

The payment service device 10 generates an after-sales token corresponding to the commodity order in response to a completion of the payment for the commodity order.

The payment service device 10 sends a commodity order confirmation email to the mail server 12 to send the commodity order confirmation email to a user mailbox corresponding to the user identification. The mail server 12 is a mail server to which the user mailbox corresponding to the user identification belongs. The commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device 10; and when the user equipment 11 accesses the after-sales link, the payment service device 10 determines the commodity order corresponding to the after-sales token to be a target order for which an after-sales service is required, and provides the after-sales service for the user according to at least one piece of target status information of the target order.

The user may log into the user mailbox in a mail client configured in the user equipment 11, or access a web page of the mail server 12 by means of the user equipment 11, log into the user mailbox on the web page, and receive the commodity order confirmation email through the user mailbox. When the user needs to conduct an after-sales service or make a complaint for the purchased commodity, the user may trigger on the user equipment 11 a request for accessing the after-sales link included in the commodity order confirmation email to access the commodity after-sales page in the payment service device, and thus conduct an after-sales service or make a complaint for the commodity.

The user equipment 11 receives the user-triggered request for accessing the after-sales link to access the commodity after-sales page in the payment service device.

When the commodity after-sales page in the payment service device 10 is accessed, the payment service device determines the commodity order corresponding to the after-sales token to be a target order for which an after-sales service is required, and provides the after-sales service for the user according to at least one piece of target status information of the target order.

### First Embodiment

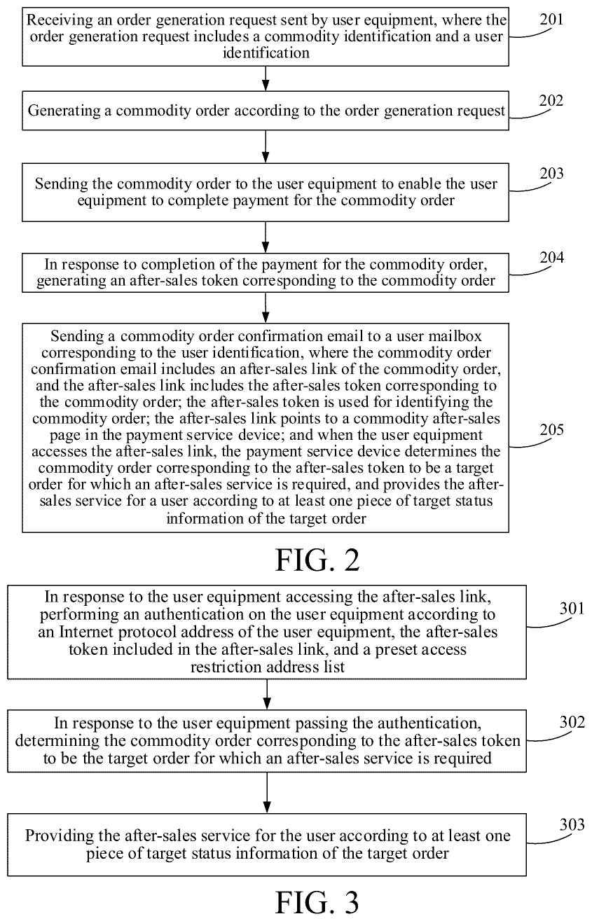

FIG. 2 is a flow diagram of a standalone website order after-sales method provided according to a first embodiment of the present application. As shown in FIG. 2, an executive subject of the present application is a standalone website order after-sales apparatus which is located in a payment service device. The standalone website order after-sales method provided in the present embodiment includes steps 201 to 205.

Step 201, receiving an order generation request sent by user equipment; where the order generation request includes a commodity identification and a user identification.

In the present embodiment, a user may browse a standalone website by means of the user equipment, and the user equipment may send the order generation request to the payment service device when the user needs to purchase a commodity in the standalone website.

The order generation request includes the commodity identification and the user identification. The commodity identification may be acquired by the user equipment from the standalone website. The order generation request may further include information such as a website address of the standalone website and a price of the commodity, etc.

Step 202, generating a commodity order according to the order generation request.

The payment service device generates the commodity order according to the order generation request. The commodity order may include information such as order generation time, the website address of the standalone website, merchant information to which the website address of the standalone website belongs, the commodity identification, the price of the commodity, and the user identification, etc.

Step 203, sending the commodity order to the user equipment to enable the user equipment to complete payment for the commodity order.

The payment service device sends the commodity order to the user equipment. After receiving the commodity order, the user equipment displays the commodity order to the user; and the user may check various information in the commodity order, and may complete the payment for the commodity order through the payment service device after determining that the various information in the commodity order is correct.

Step 204, in response to the completion of the payment for the commodity order, generating an after-sales token corresponding to the commodity order.

After sending the commodity order to the user equipment, the payment service device may acquire payment status of the commodity order in real time, and if the payment service device determines that the payment of the commodity order is completed, the after-sales token corresponding to the commodity order may be generated. The after-sales token is used for identifying the commodity order. The after-sales token may be a random string with a preset number of digits, which is not limited in the present embodiment.

Step 205, sending a commodity order confirmation email to a user mailbox corresponding to the user identification; where the commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for the user according to at least one piece of target status information of the target order.

In the present embodiment, the user mailbox corresponding to the user identification is prestored in the payment service device. Alternatively, the payment service device may acquire the user mailbox corresponding to the user identification from a preset database. After the user completes the payment for the commodity order, the payment service device sends the commodity order confirmation email to the user mailbox corresponding to the user identification.

The commodity order confirmation email includes the after-sales link of the commodity order, and the after-sales link of the commodity order includes the corresponding after-sales token. The after-sales token is used for identifying the commodity order, and thus after-sales links corresponding to different commodity orders have different after-sales tokens. The after-sales link is generated by the payment service device and points to the commodity after-sales page in the payment service device. The commodity after-sales page may be created by the payment service device in advance. Commodity after-sales pages of different commodities in the payment service device may be the same, or may be correspondingly adjusted by the payment service device according to each piece of target status information of the target order.

The commodity order confirmation email may include the commodity identification, including commodity-related information such as a commodity name, a commodity picture, an amount of money of the commodity, etc., and time of the payment for the commodity order, etc., which is not limited herein.

When accessing the after-sales link, the user equipment carries the after-sales token in the after-sales link to access the payment service device. The payment service device may determine the commodity order corresponding to the after-sales token to be the target order for which an after-sales service is required, and provide the after-sales service for the user according to at least one piece of target status information of the target order. The target status information may include status information of the commodity order, logistics status information of the commodity, refund status information of the commodity, etc.

When the commodity order is generated, the payment service device may determine merchant information corresponding to the commodity order according to the order generation request. After the payment for the commodity order is completed, the payment service device may notify a merchant corresponding to the commodity order to deliver the commodity. After delivering the commodity, the merchant may update the status information of the commodity order, the logistics status information of the commodity, etc., in the payment service device, or, after delivering the commodity, the merchant may upload the commodity logistics identification corresponding to the commodity order to the payment service device. After acquiring the commodity logistics identification corresponding to the commodity order, the payment service device may update the status information of the commodity order, the logistics status information of the commodity, etc. For example, the status information of the commodity order is updated to “delivered”, and the logistics status information of the commodity is acquired from a logistics service device according to the commodity logistics identification and is updated.

The standalone website order after-sales method provided by the present embodiment is applied to a payment service device, with which an order generation request sent by user equipment is received, where the order generation request includes a commodity identification and a user identification; a commodity order is generated according to the order generation request; the commodity order is sent to the user equipment to enable the user equipment to complete payment for the commodity order; in response to a completion of the payment for the commodity order, an after-sales token corresponding to the commodity order is generated; a commodity order confirmation email is sent to a user mailbox corresponding to the user identification, where the commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order. Since the payment service device generates the after-sales token corresponding to the commodity order after the payment for the order completes on the user equipment, the after-sales token is used to identify the commodity order, and the order confirmation email including the after-sales link is sent to the user mailbox. The after-sales link points to the payment service device, thus a user may access the payment service device through the after-sales link when the user needs an after-sales service. Since the after-sales link includes the after-sales token, when the after-sales link is accessed, the payment service device may determine, according to the after-sales token, the target order for which an after-sales service is required and may provide the after-sales service to the user with the at least one piece of target status information of the target order. In conclusion, solutions in the present application can provide a stable after-sales service to the user.

### Second Embodiment

FIG. 3 is a flow diagram of a standalone website order after-sales method provided according to a second embodiment of the present application. As shown in FIG. 3, in the standalone website order after-sales method provided in the present embodiment, on the basis of the first embodiment, step 301 to step 303 are further included after the step 205 of “sending a commodity order confirmation email to a user mailbox corresponding to the user identification”.

Step 301, in response to the user equipment accessing the after-sales link, performing an authentication on the user equipment according to an Internet protocol address of the user equipment, the after-sales token included in the after-sales link, and a preset access restriction address list.

In the present embodiment, the user equipment establishes a communication connection with the payment service device through the after-sales link and accesses the payment service device. Thus, the payment service device can acquire the Internet protocol address of the user equipment, the after-sales token included in the after-sales link accessed by the user equipment.

The preset access restriction address list may be prestored in the payment service device. The preset access restriction address list includes an Internet protocol address blocked by the payment service device.

In one embodiment, the step 301 of “performing an authentication on the user equipment according to an Internet protocol address of the user equipment, the after-sales token included in the after-sales link, and a preset access restriction address list” is refined to include steps 401 to 404.

Step 401, determining whether the Internet protocol address of the user equipment exists in the preset access restriction address list.

If the Internet protocol address of the user equipment exists in the preset access restriction address list, it is indicated that the Internet protocol address of the user equipment has been blocked by the payment service device, and the user equipment may be a device with a safety hazard. Conversely, if the Internet protocol address of the user equipment does not exist in the preset access restriction address list, it is indicated that user service equipment is not blocked by the payment service device.

In one embodiment, after step 401 of “determining whether the Internet protocol address of the user equipment exists in the preset access restriction address list”, step 501 is further included.

Step 501, in response to existence of the IP address of the user equipment in the preset access restriction address list, determining that the user equipment fails the authentication and logging an abnormal operation on the Internet protocol address of the user equipment.

Step 402, determining whether a number of digits of the after-sales token is a preset number of digits.

The after-sales token generated by the payment service device has the preset number of digits. If the number of digits of the after-sales token is not the preset number of digits, it is indicated that the after-sales token is not generated by the payment service device, there is no corresponding commodity order, and access to the after-sales link by the user equipment may be an attack on the payment service device. On the contrary, if the number of digits of the after-sales token is the preset number of digits, the after-sales token may be the after-sales token created by the payment service device.

In one embodiment, after step 402 of “determining whether a number of digits of the after-sales token is a preset number of digits”, step 502 is further included.

Step 502, in response to the number of digits of the after-sales token not being the preset number of digits, determining that the user equipment fails the authentication and logging an abnormal operation on the Internet protocol address of the user equipment.

Step 403, determining whether there is a commodity order corresponding to the after-sales token.

The after-sales token is the after-sales token created by the payment service device if there is a commodity order corresponding to the after-sales token. Conversely, if there is no commodity order corresponding to the after-sales token, the after-sales token is not the after-sales token created by the payment service device, and access to the after-sales link by the user equipment may be an attack on the payment service device.

In one embodiment, after step 403 of “determining whether there is a commodity order corresponding to the after-sales token”, step 503 is further included.

Step 503, in response to there being no commodity order corresponding to the after-sales token, determining that the user equipment fails the authentication and logging an abnormal operation on the Internet protocol address of the user equipment.

Step 404, in response to inexistence of the Internet protocol address of the user equipment in the preset access restriction address list, the number of digits of the after-sales token being the preset number of digits, and there being the commodity order corresponding to the after-sales token, determining that the user equipment passes the authentication.

In the present embodiment, if the Internet protocol address of the user equipment does not exist in the preset access restriction address list, the number of digits of the after-sales token is the preset number of digits, and there is a commodity order corresponding to the after-sales token, the payment service device determines that the user equipment passes the authentication, and provides an after-sales service to the user through an interaction with the user equipment.

Conversely, if the Internet protocol address of the user equipment exists in the preset access restriction address list, the number of digits of the after-sales token is not the preset number of digits, or there is no commodity order corresponding to the after-sales token, the payment service device determines that the user equipment fails the authentication, and intercepts access by the user equipment to the after-sales link.

The present embodiment provides the standalone website order after-sales method, by determining whether the Internet protocol address of the user equipment exists in the preset access restriction address list; determining whether the number of digits of the after-sales token is the preset number of digits; determining whether there is a commodity order corresponding to the after-sales token; and in response to inexistence of the Internet protocol address of the user equipment in the preset access restriction address list, the number of digits of the after-sales token being the preset number of digits, and there being the commodity order corresponding to the after-sales token, determining that the user equipment passes the authentication. The user can realize conducting an after-sales service or making a complaint for the commodity order by accessing the after-sales link, the payment service device provides the after-sales service for the user, and the user does not need to contact a merchant through a mailbox of the merchant. At the same time, the payment service device can verify an identity of the user equipment through the Internet protocol address, the after-sales token and the preset access restriction address list, and the user can conduct an after-sales service or make a complaint without providing information thereof, which can protect privacy of the user and improve user experience.

Step 302, in response to the user equipment passing the authentication, determining the commodity order corresponding to the after-sales token to be the target order for which an after-sales service is required.

In the present embodiment, the payment service device may construct a mapping relationship between the commodity order and the after-sales token when generating the after-sales token corresponding to the commodity order. After determining that the user equipment passes the authentication, the payment service device may determine the commodity order corresponding to the after-sales token through the preconstructed mapping relationship between the commodity order and the after-sales token, and determine the commodity order corresponding to the after-sales token to be the target order for which an after-sales service is required.

Step 303, providing the after-sales service for the user according to at least one piece of target status information of the target order.

In the present embodiment, the payment service device may acquire in advance respective pieces of target status information of all the commodity orders for which payments have been completed, store each piece of target status information in the payment service device or a preset database, and acquire target status information of the target order from a memory or the preset database after the target order is determined. The payment service device may also acquire each piece of target status information of the target order after the target order is determined.

In the present embodiment, the after-sales link accessed by the user equipment may point to a preset commodity after-sales page in the payment service device, a user accesses the commodity after-sales page by means of the user equipment, and the payment service device may display each piece of target status information of the target order to the user by means of the commodity after-sales page and provide an after-sales service for the user.

The present embodiment provides a standalone website order after-sales method, with which the authentication on the user equipment is performed according to the Internet protocol address of the user equipment, the after-sales token included in the after-sales link, and the preset access restriction address list in response to the user equipment accessing the after-sales link; the commodity order corresponding to the after-sales token is determined to be the target order for which an after-sales service is required, in response to the user equipment passing the authentication; and the after-sales service is provided for the user according to the at least one piece of target status information of the target order. Since the commodity after-sales page to which the after-sales link points is in the payment service device, the after-sales link will not be invalid, and after the after-sales link is accessed, the payment service device can determine the target order and provide an after-sales service for the user according to the target status information, ensuring the after-sales service for the commodity order. Therefore, the user can access the after-sales link when an after-sales service is required and conduct the after-sales service in the commodity after-sales page.

In one embodiment, step 504 is further included after “logging an abnormal operation on the Internet protocol address of the user equipment” in step 501, step 502, and step 503.

Step 504, in response to the abnormal operation being logged on a same Internet protocol address for a number of times greater than or equal to a preset number of times, adding the Internet protocol address to the preset access restriction address list.

In the present embodiment, if the abnormal operation is logged on the same Internet protocol address for the number of times greater than or equal to the preset number of times, it is possible that a device corresponding to the Internet protocol address is conducting an attack on the payment service device, and therefore, in order to ensure security of the payment service device and the after-sales link of the commodity order, the Internet protocol address, where the Internet protocol address being logged with the abnormal operation for the number of times greater than or equal to the preset number, is added to the preset access restriction address list, to restrict the device corresponding to the Internet protocol address from accessing the payment service device. The preset number of times can be 3.

The present embodiment provides a standalone website order after-sales method, with which a determination that the user equipment fails the authentication is made in response to the existence of the IP address of the user equipment in the preset access restriction address list, and an abnormal operation on the Internet protocol address of the user equipment is logged; a determination that the user equipment fails the authentication is made in response to the number of digits of the after-sales token not being the preset number of digits and an abnormal operation on the Internet protocol address of the user equipment is logged; a determination that the user equipment fails the authentication is made in response to there being no commodity order corresponding to the after-sales token and an abnormal operation on the Internet protocol address of the user equipment is logged; and, in response to the abnormal operation being logged on the same Internet protocol address for the number of times greater than or equal to the preset number, the Internet protocol address is added to the preset access restriction address list. Since a user may directly click the after-sales link in the commodity order confirmation email to conduct an after-sales service when the user needs the after-sales service, a plurality of abnormal operations generally will not occur in normal user equipment. Thus, adding the Internet protocol address, logged with the abnormal operation for a number of times greater than or equal to the preset number of times, to the preset access restriction address list can protect security of the after-sales link of the order, avoid an attacking device from maliciously conducting an after-sales service, and avoid leakage of target status information of commodity orders.

In one embodiment, step 303 “providing the after-sales service for the user according to at least one piece of target status information of the target order” is refined to include steps 601 to 605.

Step 601, sending after-sales type information to the user equipment; where the after-sales type information includes a plurality of preset types; and at least one preset type has preset status information and a preset text corresponding thereto.

In the present embodiment, the preset type may be a preset after-sales type. For example, the preset after-sales type may be a type such as order, refund, refusal of payment, logistics, etc. The after-sales type information may be information displayed in the commodity after-sales page. The payment service device sends the after-sales type information to the user equipment so that the user equipment displays the after-sales type information in the after-sales page. The preset type may be displayed in the after-sales page in a form of a tag for the user to select.

In the present embodiment, the at least one preset type has the preset status information corresponding thereto, for example, the logistics may correspond to logistics status information of a commodity, and the refund may correspond to refund status information of the commodity. The preset text may include a plurality of preset fields which may be fields replaced according to different pieces of status information of different commodity orders, for example, the preset text may include an order number, and the order number may be replaced adaptively according to order numbers of different commodity orders.

Step 602, receiving an after-sales request sent by the user equipment; where the after-sales request includes at least one target type selected by the user from the plurality of preset types.

In the present embodiment, after accessing the after-sales page, the user may select, in the after-sales page, at least one target type for which an after-sales service is required, and the user equipment generates the after-sales request according to the target type selected by the user and sends the after-sales request to the payment service device.

Step 603, if it is determined that there is target status information corresponding to the target type in each piece of target status information, generating an after-sales text corresponding to the target type according to the target status information and a preset text corresponding to the target type.

In one embodiment, the preset text includes at least one preset status field, and the target status information includes at least one target status field; the “generating an after-sales text corresponding to the target type according to the target status information and a preset text corresponding to the target type” in step 603 is refined to include step 701.

Step 701, replacing, with a value of each target status field, a value of a preset status field in the preset text corresponding to a target status field, to obtain the after-sales text corresponding to the target type.

For example, a preset status field in a preset text corresponding to a logistics type include a logistics company, a logistics order number, a current location of a commodity, etc. Target logistics status information includes a logistics company, a logistics order number, a current location of the commodity, etc. The payment service device may replace the logistics company, the logistics order number, the current location of the commodity, etc., included in the preset status field in the preset text with the logistics company, the logistics order number, the current location of the commodity, etc., included in the target logistics status information, to obtain the after-sales text corresponding to the logistics type.

In the standalone website order after-sales method provided in the present embodiment, the after-sales text corresponding to the target type is obtained by replacing, with the value of each target status field, the value of the preset status field in the preset text corresponding to the target status field. Since the payment service device can generate a corresponding after-sales text directly according to the target type selected by the user, efficiency of the after-sales service can be improved.

Step 604, if it is determined that there is no target status information corresponding to the target type in each piece of target status information, sending the target type to a target after-sales device preset by a merchant corresponding to the target order, so that the target after-sales device generates an after-sales text corresponding to the target type and send the after-sales text to the payment service device.

In the present embodiment, the target after-sales device preset by the merchant corresponding to the target order may be a contact device of a staff service reserved by the merchant.

Step 605, sending after-sales information to the user equipment to provide an after-sales service for the user; where the after-sales information includes an after-sales text corresponding to each target type.

In the present embodiment, the after-sales information is used to respond to the after-sales request sent by the user equipment. For example, if the user inquires about logistics of a commodity, the after-sales information includes logistics status information of the commodity.

In one embodiment, the after-sales type information may be a two-layer structure, where a first layer is a plurality of preset types, and a second layer is a specific after-sales item in the preset types. For example, the preset types may be refund, logistics, complaint, etc., and a specific after-sales item in the refund may include a progress of the refund, an amount of the refund, etc. A specific after-sales item in the logistics may include a logistics company, a logistics order number, an estimated delivery time of the logistics, etc. A specific after-sales item in the complaint may include a complaint against a merchant, a complaint against a commodity, a complaint against logistics, etc. The payment service device may generate a refined after-sales text according to a preset text corresponding to the specific after-sales item to improve after-sales experience of the user.

The present embodiment provides a standalone website order after-sales method, where since the payment service device generates the corresponding after-sales text according to the target type selected by the user, a targeted response can be made according to the user's after-sales needs. Moreover, the payment service device can quickly generate an accurate after-sales text according to target status information and a preset text, thus, after-sales efficiency can be improved.

In one embodiment, after “sending the target type to a target after-sales device preset by a merchant corresponding to the target order” in step 604, steps 801 to 802 are further included.

Step 801: inputting the target type, a preset reply demand corresponding to the target type, and each piece of target status information into a preset generative conversational language model, and generating an auxiliary text corresponding to the target type with the preset generative conversational language model.

In the present embodiment, the preset generative conversational language model, which is a Generative Pre-trained Transformer, is a deep learning model for text generation which is trained based on data available on the Internet. It may be used for question answering, text summary generation, machine translation, classification, code generation, and conversation. The preset reply demand is preset by the merchant in the payment service device for each target type, for example, when the target type is refund, the preset reply demand of the merchant may be no refund, a refund of 30% of the amount of the commodity order, etc. The payment service device inputs the target status information of the commodity order, the target type for which a corresponding auxiliary text needs to be generated, and the preset reply demand corresponding to the target type into the preset generative conversational language model. The preset generative conversational language model may generate the auxiliary text corresponding to the target type.

Step 802, sending the auxiliary text to the target after-sales device; where the auxiliary text is used to assist the target after-sales device in generating the after-sales text corresponding to the target type.

In the present embodiment, the auxiliary text is sent to the target after-sales device, where the target after-sales device may be a contact device of a staff service reserved by the merchant, and the auxiliary text may be used for reference by the staff service, which improves the after-sales efficiency of the staff service and saves human resources.

The present embodiment provides a standalone website order after-sales method, where since according to target order status, the target type and the preset reply demand corresponding thereto, the preset generative conversational language model generates the auxiliary text corresponding to the target type for reference by the target after-sales device, the after-sales efficiency is further improved.

### Third Embodiment

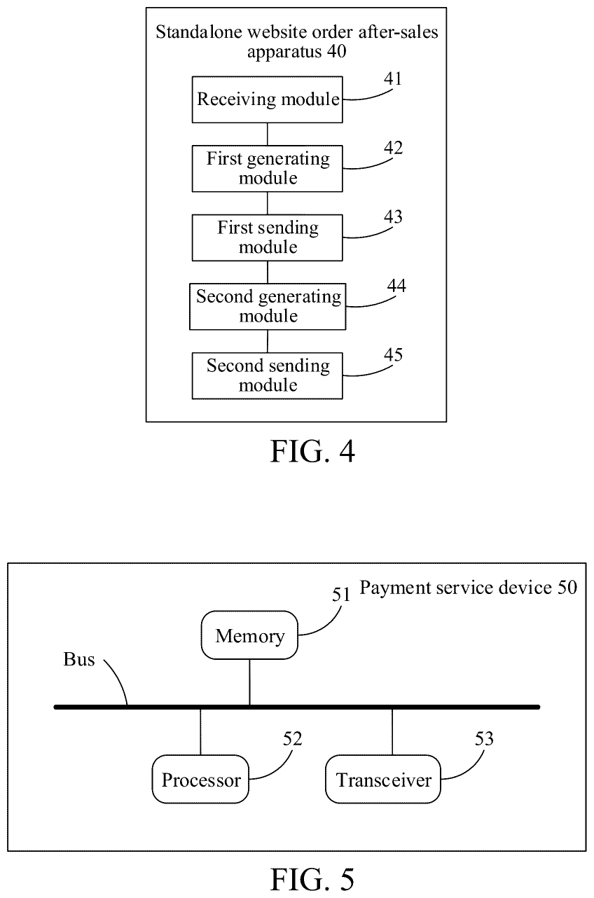

FIG. 4 is a structure diagram of a standalone website order after-sales apparatus provided according to the third embodiment of the present application. As shown in FIG. 4, the standalone website order after-sales apparatus 40 provided in the present embodiment includes: a receiving module 41, a first generating module 42, a first sending module 43, a second generating module 44, and a second sending module 45.

The receiving module 41 is configured to receive an order generation request sent by user equipment; where the order generation request includes a commodity identification and a user identification.

The first generating module 42 is configured to generate a commodity order according to the order generation request.

The first sending module 43 is configured to send the commodity order to the user equipment to enable the user equipment to complete payment for the commodity order.

The second generating module 44 is configured to generate an after-sales token corresponding to the commodity order in response to a completion of the payment for the commodity order.

The second sending module 45 is configured to send a commodity order confirmation email to a user mailbox corresponding to the user identification; where the commodity order confirmation email includes an after-sales link of the commodity order, and the after-sales link includes the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order.

In one embodiment, the standalone website order after-sales apparatus further includes an after-sales module configured to:
in response to the user equipment accessing the after-sales link, perform an authentication on the user equipment according to an Internet protocol address of the user equipment, the after-sales token included in the after-sales link, and a preset access restriction address list;
in response to the user equipment passing the authentication, determine the commodity order corresponding to the after-sales token to be the target order for which an after-sales service is required; and provide the after-sales service for the user according to at least one piece of target status information of the target order.

In one embodiment, the after-sales module, when configured to perform the authentication on the user equipment according to the Internet protocol address of the user equipment, the after-sales token included in the after-sales link, and the preset access restriction address list, is specifically configured to:
determine whether the Internet protocol address of the user equipment exists in the preset access restriction address list;
determine whether a number of digits of the after-sales token is a preset number of digits;
determine whether there is a commodity order corresponding to the after-sales token; and
in response to inexistence of the Internet protocol address of the user equipment in the preset access restriction address list, the number of digits of the after-sales token being the preset number of digits, and there being the commodity order corresponding to the after-sales token, determine that the user equipment passes the authentication.

In one embodiment, the after-sales module is further specifically configured to:
in response to existence of the IP address of the user equipment in the preset access restriction address list, determine that the user equipment fails the authentication and log an abnormal operation on the Internet protocol address of the user equipment;
in response to the number of digits of the after-sales token not being the preset number of digits, determine that the user equipment fails the authentication and log an abnormal operation on the Internet protocol address of the user equipment;
in response to there being no commodity order corresponding to the after-sales token, determine that the user equipment fails the authentication and log an abnormal operation on the Internet protocol address of the user equipment; and
in response to the abnormal operation being logged on a same Internet protocol address for a number of times greater than or equal to a preset number, add the Internet protocol address to the preset access restriction address list.

In one embodiment, the after-sales module, when configured to provide the after-sales service for the user according to the at least one piece of target status information of the target order, is specifically configured to:
send after-sales type information to the user equipment; where the after-sales type information includes a plurality of preset types; and at least one preset type has preset status information and a preset text corresponding thereto;
receive an after-sales request sent by the user equipment; where the after-sales request includes at least one target type selected by the user from the plurality of preset types;
if it is determined that there is target status information corresponding to the target type in each piece of target status information, generate an after-sales text corresponding to the target type according to the target status information and a preset text corresponding to the target type;
if it is determined that there is no target status information corresponding to the target type in each piece of target status information, send the target type to a target after-sales device preset by a merchant corresponding to the target order, so that the target after-sales device generates an after-sales text corresponding to the target type and sends the after-sales text to the payment service device; and
send after-sales information to the user equipment to provide an after-sales service for the user; where the after-sales information includes an after-sales text corresponding to each target type.

In one embodiment, the preset text includes at least one preset status field, the target status information includes at least one target status field, and the after-sales module, when configured to generate the after-sales text corresponding to the target type according to the target status information and the preset text corresponding to the target type, is specifically configured to:
replace, with a value of each target status field, a value of a preset status field in the preset text corresponding to a target status field, to obtain the after-sales text corresponding to the target type.

In one embodiment, the after-sales module is further specifically configured to:
input the target type, a preset reply demand corresponding to the target type, and each piece of target status information into a preset generative conversational language model, and generate an auxiliary text corresponding to the target type with the preset generative conversational language model; and
send the auxiliary text to the target after-sales device; where the auxiliary text is used to assist the target after-sales device in generating the after-sales text corresponding to the target type.

The standalone website order after-sales apparatus provided in the present embodiment can perform the standalone website order after-sales method provided in any of the above-mentioned embodiments, and specific implementation manners and principles are similar and will not be repeated herein.

### Fourth Embodiment

FIG. 5 is a structure diagram of a payment service device provided according to the fourth embodiment of the present application. As shown in FIG. 5, the payment service device 50 provided in the present embodiment includes: a memory 51, a processor 52, and a transceiver 53.

The memory 51, processor 52, and transceiver 53 are interconnected through a circuitry.

The memory 51 stores a computer executable instruction.

The transceiver 53 is configured to send and receive data.

The processor 52 executes the computer executable instruction stored in the memory 51 to implement the standalone website order after-sales method provided in any of the above-mentioned embodiments, and specific implementation manners and principles are similar and will not be repeated herein.

A circuitry interconnection can be realized among the memory 51, the processor 52, and the transceiver 53 through a bus. The bus may be an industry standard architecture (abbreviated as ISA) bus, a peripheral component interconnect (abbreviated as PCI) bus, or an extended industry standard architecture (abbreviated as EISA) bus, etc. The bus may be categorized as an address bus, a data bus, a control bus, etc. For ease of representation, only one thick line is shown in FIG. 5, which, however, does not represent that there is only one bus or one type of bus.

The memory may be implemented by any type of volatile or non-volatile storage device or a combination thereof, e.g., a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or a compact disc, etc.

In an exemplary embodiment, the payment service device may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for performing the above-mentioned standalone website order after-sales method.

An embodiment of the present application further provides a computer readable storage medium, the computer readable storage medium having a computer executable instruction stored therein, and the computer executable instruction, when executed by a processor, is used to implement the standalone website order after-sales method as provided in any of the above-mentioned embodiments, and specific implementation manners and principles are similar and will not be repeated herein. For example, the computer readable storage medium may be a read only memory, a random access memory, a magnetic tape, a floppy disk, an optical data storage device, etc.

An embodiment of the present application further provides a computer program product including a computer program which, when executed by a processor, implements the standalone website order after-sales method provided in any of the above-mentioned embodiments, and specific implementation manners and principles are similar and will not be repeated herein.

It should be understood that the above-mentioned device embodiments are only schematic, and the device in the present application may be implemented in other ways. For example, the division of modules in the above-mentioned embodiments is only a logical functional division, and there may be other ways of division in an actual implementation. For example, a plurality of modules may be combined, or may be integrated into another system, or some features may be ignored or not implemented.

In addition, if not otherwise specified, various functional modules in various embodiments of the present application may be integrated in a single module, or the various modules may physically exist individually, or two or more modules may be integrated together. The above-mentioned integrated module may be implemented either in a form of hardware or in a form of a software program module.

It should be noted that, the aforementioned method embodiments are all described as a series of action combinations for the sake of simple description, but the person skilled in the art should be aware that the present application is not limited by the described action sequence, because according to the present application, some steps may be performed in other sequences or at the same time. Secondly, the person skilled in the art should also be aware that the actions and modules involved in the embodiments described in the specification are not necessarily necessary for the present application.

It is further noted that although individual steps in the flow diagram are shown sequentially as indicated by arrows, these steps are not necessarily executed sequentially in a sequence indicated by the arrows. Unless clearly stated herein, there is no strict sequence limitation on the execution of these steps, and the steps may be executed in other sequences. Moreover, at least a part of the steps in the flow diagram may include a plurality of sub-steps or a plurality of phases which are not necessarily executed completely at the same moment but may be executed at different moments, and a sequence in which these sub-steps or phases are executed is not necessarily sequential, but may be executed in turn or alternatively with at least a part of other steps or sub-steps or phases of the other steps.

Other embodiments of the present application will easily come to mind to those skilled in the art upon consideration of the specification and practice of the invention disclosed herein. The present application is intended to cover any variation, use, or adaptation thereof which follow a general principle of the present application and include common knowledge or conventional technical means in the art which are not disclosed herein. The specification and the embodiments are regarded as exemplary only, and the true scope and spirit of the present application are indicated by following claims.

It should be understood that the present application is not limited to a precise structure which has been described above and illustrated in the drawings, and various modifications and changes may be made without departing from scope thereof. The scope of the present application is limited only by the appended claims.

What is claimed is:

1. A standalone website order after-sales method, applied to a payment service device, comprising:
receiving an order generation request sent by user equipment, wherein the order generation request comprises a commodity identification and a user identification;
generating a commodity order according to the order generation request;
sending the commodity order to the user equipment to enable the user equipment to complete payment for the commodity order;
in response to a completion of the payment for the commodity order, generating an after-sales token corresponding to the commodity order; and
sending a commodity order confirmation email to a user mailbox corresponding to the user identification, wherein the commodity order confirmation email comprises an after-sales link of the commodity order, and the after-sales link comprises the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order.

2. The method according to claim 1, after the sending the commodity order confirmation email to the user mailbox corresponding to the user identification, further comprising:
in response to the user equipment accessing the after-sales link, performing an authentication on the user equipment according to an Internet protocol address of the user equipment, the after-sales token comprised in the after-sales link, and a preset access restriction address list;
in response to the user equipment passing the authentication, determining the commodity order corresponding to the after-sales token to be the target order for which an after-sales service is required; and
providing the after-sales service for the user according to at least one piece of target status information of the target order.

3. The method according to claim 2, wherein the performing the authentication on the user equipment according to the Internet protocol address of the user equipment, the after-sales token comprised in the after-sales link, and the preset access restriction address list, comprises:
determining whether the Internet protocol address of the user equipment exists in the preset access restriction address list;
determining whether a number of digits of the after-sales token is a preset number of digits;
determining whether there is a commodity order corresponding to the after-sales token; and
in response to inexistence of the Internet protocol address of the user equipment in the preset access restriction address list, the number of digits of the after-sales token being the preset number of digits, and there being the commodity order corresponding to the after-sales token, determining that the user equipment passes the authentication.

4. The method according to claim 3, after the determining whether the Internet protocol address of the user equipment exists in the preset access restriction address list, further comprising:
in response to existence of the Internet protocol address of the user equipment in the preset access restriction address list, determining that the user equipment fails the authentication and logging an abnormal operation on the Internet protocol address of the user equipment;
after the determining whether the number of digits of the after-sales token is the preset number of digits, further comprising:
in response to the number of digits of the after-sales token not being the preset number of digits, determining that the user equipment fails the authentication and logging an abnormal operation on the Internet protocol address of the user equipment;
after the determining whether there is the commodity order corresponding to the after-sales token, further comprising:
in response to there being no commodity order corresponding to the after-sales token, determining that the user equipment fails the authentication and logging an abnormal operation on the Internet protocol address of the user equipment; and
after the logging the abnormal operation on the Internet protocol address of the user equipment, further comprising:
in response to the abnormal operation being logged on a same Internet protocol address for a number of times greater than or equal to a preset number of times, adding the Internet protocol address to the preset access restriction address list.

5. The method according to claim 2, wherein the providing the after-sales service for the user according to the at least one piece of target status information of the target order, comprises:
sending after-sales type information to the user equipment; wherein the after-sales type information comprises a plurality of preset types; and at least one preset type has preset status information and a preset text corresponding thereto;
receiving an after-sales request sent by the user equipment; wherein the after-sales request comprises at least one target type selected by the user from the plurality of preset types;
if it is determined that there is target status information corresponding to the target type in each piece of target status information, generating an after-sales text corresponding to the target type according to the target status information and a preset text corresponding to the target type;
if it is determined that there is no target status information corresponding to the target type in each piece of target status information, sending the target type to a target after-sales device preset by a merchant corresponding to the target order, so that the target after-sales device generates an after-sales text corresponding to the target type and sends the after-sales text to the payment service device; and
sending after-sales information to the user equipment to provide the after-sales service for the user; wherein the after-sales information comprises an after-sales text corresponding to each target type.

6. The method according to claim 5, wherein the preset text comprises at least one preset status field, and the target status information comprises at least one target status field; the generating the after-sales text corresponding to the target type according to the target status information and the preset text corresponding to the target type, comprises:
replacing, with a value of each target status field, a value of a preset status field in the preset text corresponding to the target status field, to obtain the after-sales text corresponding to the target type.

7. The method according to claim 5, after the sending the target type to the target after-sales device preset by the merchant corresponding to the target order, further comprising:
inputting the target type, a preset reply demand corresponding to the target type, and each piece of target status information into a preset generative conversational language model, and generating an auxiliary text corresponding to the target type with the preset generative conversational language model; and
sending the auxiliary text to the target after-sales device; wherein the auxiliary text is used to assist the target after-sales device in generating the after-sales text corresponding to the target type.

8. A standalone website order after-sales apparatus, applied to a payment service device, comprising: a memory, a processor, and a transceiver;
wherein the memory, the processor, and the transceiver are interconnected through a circuitry;
the memory stores a computer executable instruction;
the transceiver is configured to send and receive data; and
the processor executes the computer executable instruction stored in the memory to implement:
receiving an order generation request sent by user equipment; wherein the order generation request comprises a commodity identification and a user identification;
generating a commodity order according to the order generation request;
sending the commodity order to the user equipment to enable the user equipment to complete payment for the commodity order;
generating an after-sales token corresponding to the commodity order in response to a completion of the payment for the commodity order; and
sending a commodity order confirmation email to a user mailbox corresponding to the user identification; wherein the commodity order confirmation email comprises an after-sales link of the commodity order, and the after-sales link comprises the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order.

9. The apparatus according to claim 8, wherein the processor executes the computer executable instruction stored in the memory to further implement:
in response to the user equipment accessing the after-sales link, performing an authentication on the user equipment according to an Internet protocol address of the user equipment, the after-sales token comprised in the after-sales link, and a preset access restriction address list;
in response to the user equipment passing the authentication, determining the commodity order corresponding to the after-sales token to be the target order for which an after-sales service is required; and
providing the after-sales service for the user according to at least one piece of target status information of the target order.

10. The apparatus according to claim 9, wherein the processor executes the computer executable instruction stored in the memory to further implement:
determining whether the Internet protocol address of the user equipment exists in the preset access restriction address list;
determining whether a number of digits of the after-sales token is a preset number of digits;
determining whether there is a commodity order corresponding to the after-sales token; and
in response to inexistence of the Internet protocol address of the user equipment in the preset access restriction address list, the number of digits of the after-sales token being the preset number of digits, and there being the commodity order corresponding to the after-sales token, determining that the user equipment passes the authentication.

11. The apparatus according to claim 10, wherein the processor executes the computer executable instruction stored in the memory to further implement:
in response to existence of the Internet protocol address of the user equipment in the preset access restriction address list, determining that the user equipment fails the authentication and logging an abnormal operation on the Internet protocol address of the user equipment;
in response to the number of digits of the after-sales token not being the preset number of digits, determining that the user equipment fails the authentication and logging an abnormal operation on the Internet protocol address of the user equipment;
in response to there being no commodity order corresponding to the after-sales token, determining that the user equipment fails the authentication and logging an abnormal operation on the Internet protocol address of the user equipment; and
in response to the abnormal operation being logged on a same Internet protocol address for a number of times greater than or equal to a preset number of times, adding the Internet protocol address to the preset access restriction address list.

12. The apparatus according to claim 9, wherein the processor executes the computer executable instruction stored in the memory to further implement:
sending after-sales type information to the user equipment; wherein the after-sales type information comprises a plurality of preset types; and at least one preset type has preset status information and a preset text corresponding thereto;
receiving an after-sales request sent by the user equipment; wherein the after-sales request comprises at least one target type selected by the user from the plurality of preset types;
if it is determined that there is target status information corresponding to the target type in each piece of target status information, generating an after-sales text corresponding to the target type according to the target status information and a preset text corresponding to the target type;
if it is determined that there is no target status information corresponding to the target type in each piece of target status information, sending the target type to a target after-sales device preset by a merchant corresponding to the target order, so that the target after-sales device generates an after-sales text corresponding to the target type and sends the after-sales text to the payment service device; and
sending after-sales information to the user equipment to provide the after-sales service for the user; wherein the after-sales information comprises an after-sales text corresponding to each target type.

13. The apparatus according to claim 12, wherein the preset text comprises at least one preset status field, and the target status information comprises at least one target status field;
and the processor executes the computer executable instruction stored in the memory to further implement:
replacing, with a value of each target status field, a value of a preset status field in the preset text corresponding to the target status field, to obtain the after-sales text corresponding to the target type.

14. The apparatus according to claim 12, wherein the processor executes the computer executable instruction stored in the memory to further implement:
inputting the target type, a preset reply demand corresponding to the target type, and each piece of target status information into a preset generative conversational language model, and generating an auxiliary text corresponding to the target type with the preset generative conversational language model; and
sending the auxiliary text to the target after-sales device; wherein the auxiliary text is used to assist the target after-sales device in generating the after-sales text corresponding to the target type.

15. A non-transitory computer readable storage medium having a computer executable instruction stored therein, wherein the computer executable instruction, when executed by a processor, is used to implement:
receiving an order generation request sent by user equipment, wherein the order generation request comprises a commodity identification and a user identification;
generating a commodity order according to the order generation request;
sending the commodity order to the user equipment to enable the user equipment to complete payment for the commodity order;
in response to a completion of the payment for the commodity order, generating an after-sales token corresponding to the commodity order; and
sending a commodity order confirmation email to a user mailbox corresponding to the user identification, wherein the commodity order confirmation email comprises an after-sales link of the commodity order, and the after-sales link comprises the after-sales token corresponding to the commodity order; the after-sales token is used for identifying the commodity order; the after-sales link points to a commodity after-sales page in the payment service device; and when the user equipment accesses the after-sales link, the payment service device determines the commodity order corresponding to the after-sales token to be a target order for which an after-sales service is required, and provides the after-sales service for a user according to at least one piece of target status information of the target order.

16. The non-transitory computer readable storage medium according to claim 15, wherein the computer executable instruction, when executed by the processor, is further used to implement:
in response to the user equipment accessing the after-sales link, performing an authentication on the user equipment according to an Internet protocol address of the user equipment, the after-sales token comprised in the after-sales link, and a preset access restriction address list;
in response to the user equipment passing the authentication, determining the commodity order corresponding to the after-sales token to be the target order for which an after-sales service is required; and
providing the after-sales service for the user according to at least one piece of target status information of the target order.

17. The non-transitory computer readable storage medium according to claim 16, wherein the computer executable instruction, when executed by the processor, is further used to implement:
determining whether the Internet protocol address of the user equipment exists in the preset access restriction address list;
determining whether a number of digits of the after-sales token is a preset number of digits;
determining whether there is a commodity order corresponding to the after-sales token; and
in response to inexistence of the Internet protocol address of the user equipment in the preset access restriction address list, the number of digits of the after-sales token being the preset number of digits, and there being the commodity order corresponding to the after-sales token, determining that the user equipment passes the authentication.

18. The non-transitory computer readable storage medium according to claim 17, wherein the computer executable instruction, when executed by the processor, is further used to implement:
in response to existence of the Internet protocol address of the user equipment in the preset access restriction address list, determining that the user equipment fails the authentication and logging an abnormal operation on the Internet protocol address of the user equipment;
in response to the number of digits of the after-sales token not being the preset number of digits, determining that the user equipment fails the authentication and logging an abnormal operation on the Internet protocol address of the user equipment;
in response to there being no commodity order corresponding to the after-sales token, determining that the user equipment fails the authentication and logging an abnormal operation on the Internet protocol address of the user equipment; and
in response to the abnormal operation being logged on a same Internet protocol address for a number of times greater than or equal to a preset number of times, adding the Internet protocol address to the preset access restriction address list.

19. The non-transitory computer readable storage medium according to claim 16, wherein the computer executable instruction, when executed by the processor, is further used to implement:
sending after-sales type information to the user equipment; wherein the after-sales type information comprises a plurality of preset types; and at least one preset type has preset status information and a preset text corresponding thereto;
receiving an after-sales request sent by the user equipment; wherein the after-sales request comprises at least one target type selected by the user from the plurality of preset types;
if it is determined that there is target status information corresponding to the target type in each piece of target status information, generating an after-sales text corresponding to the target type according to the target status information and a preset text corresponding to the target type;
if it is determined that there is no target status information corresponding to the target type in each piece of target status information, sending the target type to a target after-sales device preset by a merchant corresponding to the target order, so that the target after-sales device generates an after-sales text corresponding to the target type and sends the after-sales text to the payment service device; and
sending after-sales information to the user equipment to provide the after-sales service for the user; wherein the after-sales information comprises an after-sales text corresponding to each target type.

20. The non-transitory computer readable storage medium according to claim 19, wherein the preset text comprises at least one preset status field, and the target status information comprises at least one target status field; and the computer executable instruction, when executed by the processor, is further used to implement:
replacing, with a value of each target status field, a value of a preset status field in the preset text corresponding to the target status field, to obtain the after-sales text corresponding to the target type.
